(19) United States
(12) Patent Application Publication
(10) Pub. No.: US 2026/0350641 A1
(43) Pub. Date: Nov. 5, 2026

(54) SPATIOTEMPORAL PROFILING ANALYSIS METHOD FOR INDIVIDUALS AND LOCATIONS BASED ON PERCEPTUAL DATA

(71) Applicant: Hangzhou Bywin Technology Co., Ltd., Hangzhou City, Zhejiang Province (CN)

(72) Inventors: Xiping CHEN, Hangzhou City (CN); Weiqiang CHEN, Hangzhou City (CN); Yuejian XIA, Hangzhou City (CN); Jiawei YAO, Hangzhou City (CN); Jianwei LIANG, Hangzhou City (CN); Chun NI, Hangzhou City (CN)

(21) Appl. No.: 19/449,467

(22) Filed: Jan. 15, 2026

(30) Foreign Application Priority Data
Jan. 15, 2025 (CN) 2025100588806

(51) Int. Cl. G06Q 30/0201; G06F 16/215; G06F 16/25; G06F 16/906; G06F 16/909

(52) U.S. Cl. CPC G06Q 30/02011; G06F 16/215; G06F 16/258; G06F 16/906; G06F 16/909

(57) ABSTRACT

The present disclosure relates to the technical field of profiling analysis, and discloses a spatiotemporal profiling analysis method for individuals and locations based on perceptual data, comprising the following steps: aggregating perceptual data captured by perceptual devices including cameras and access control; preprocessing the perceptual data that captured; extracting behavioral features from individuals and vehicles trajectory data in the perceptual data, classifying and organizing them, and establishing relevant databases; establishing correlation relationships among individuals, vehicles, and locations across different dimensions within a cycle based on the extracted data; aggregating the correlation relationships between individuals and locations; constructing spatiotemporal profiling of individuals and locations related to specific business operations.

### CROSS-REFERENCE TO RELATED APPLICATIONS

The present application claims priority of Chinese Patent Application No. 202510058880.6, filed on Jan. 15, 2025, the entire contents of which are hereby incorporated by reference.

### TECHNICAL FIELD

The present disclosure relates to the technical field of profiling analysis, and particularly to a spatiotemporal profiling analysis method for individuals and locations based on perceptual data.

### BACKGROUND

Perceptual data refers to data sensed, measured, and transmitted by perceptual devices or sensing devices. With the rapid development of smart city technologies and the improvement of social security requirements, perceptual devices such as cameras and access control systems are widely distributed in cities, and video surveillance basically covers public areas, providing hardware foundation and data support for spatiotemporal profiling analysis of individuals and locations. By drawing spatiotemporal profiling of individuals and locations, relevant departments can have a clearer understanding of urban individuals and locations, improve the prevention and control capabilities of urban risk events and security scheduling capabilities, and ensure urban order and safety.

Although existing technologies can identify personnel in videos through algorithms and draw their trajectories, they lack effective sorting and aggregation of the spatiotemporal characteristics of these data. Specifically, existing systems usually only record the position of personnel at a certain time point, but fail to combine this position information with time information to form a complete spatiotemporal trajectory, resulting in the inability to fully understand the activity patterns and behavioral rules of personnel. In addition, existing technologies have not fully considered the overall characteristics of the group of personnel coming and going in places, such as passenger flow, crowd density, and crowd flow direction, ignoring the importance of group behavior analysis. Especially when evaluating the connections between personnel, existing technologies based on simple statistics of trajectory overlap cannot accurately evaluate the correlation between personnel and the crowd profiling of places.

Therefore, existing perceptual data analysis methods have obvious deficiencies in the integration of spatiotemporal characteristics, group behavior analysis, and refinement of multi-dimensional correlation degrees, which limits the in-depth understanding and application of the general characteristics of urban individuals and locations.

Therefore, it is necessary to design a spatiotemporal profiling analysis method for individuals and locations based on perceptual data to solve the above problems.

### SUMMARY

The purpose of the present disclosure is to propose a spatiotemporal profiling analysis method for individuals and locations based on perceptual data to solve the shortcomings existing in the prior art.

To achieve the above purpose, the present disclosure adopts the following technical scheme:

A spatiotemporal profiling analysis method for individuals and locations based on perceptual data, including steps of:
S1: aggregating perceptual data captured by perceptual devices including cameras and access control;
S2: preprocessing the perceptual data that captured;
S3: extracting behavioral features from individuals and vehicles trajectory data in the perceptual data, classifying and organizing them, and establishing relevant databases;
S4: establishing correlation relationships among individuals, vehicles, and locations across different dimensions within a cycle based on the extracted data;
S5: aggregating the correlation relationships between individuals and locations;
S6: constructing spatiotemporal profiling of individuals and locations related to specific business operations.

In an embodiment of the present disclosure, the preprocessing in step S2 includes:
deduplication and redundancy processing of data by detecting and removing duplicates using hash function to reduce storage space;
processing missing values and outliers by filling missing values, removing and correcting outliers;
formatting and standardizing data by standardizing data from different sensors and systems into unified data type and format;
converting and processing data according to different business requirements;
verifying data quality and reliability after data cleaning and preprocessing.

In an embodiment of the present disclosure, the relevant databases in the step S3 include: a location database of associations between the locations and the perceptual devices, which is established based on geographical locations and the latitude and longitude data of the perceptual devices, an association table of a target location being obtained from the location database as a first location table, association tables of those other than the first location obtained from the location database as second location tables; an individual trajectory database established by aggregating individual trajectory information, a first trajectory table of a target individual being obtained from the individual trajectory database, and second trajectory tables being those obtained from the individual trajectory database other than the first trajectory table; and a vehicle trajectory database established by aggregating vehicle trajectory information.

In an embodiment of the present disclosure, the spatiotemporal profiling in the step S6 include: relationship profiling between the target individual and individuals corresponding to the second trajectory table, which is determined based on a correlation degree and meeting locations between the target individual and the individual corresponding to the second trajectory table; trajectory profiling of the target individual, which is determined based on a number and time of overlap between the trajectory of the target individual and the locations in the location database; portrait group profiling of the target location, which is determined based on an overlap between the target location and the individual trajectories in the individual trajectory database; vehicle group profiling of the target location, which is determined based on an overlap between the target location and the vehicle trajectories in the vehicle trajectory database.

In an embodiment of the present disclosure, the acquisition mechanism of the relationship profiling is as follows: within a time period [t1, t2], determining the correlation degree A_{uV}(t1, t2) between the target individual u and the individuals V corresponding to the second trajectory table according to the number of trajectory overlaps C_{uV}(t1, t2) between the target individual u and the individuals V={v1, v2, v3 . . . vq} in the second trajectory table within a time range less than a threshold Δt, where q represents a total number of individuals in the second trajectory table; within the time period [t1, t2], determining the meeting locations M_{uV}(t1,t2) between the target individual and the individuals corresponding to the second trajectory table according to the position information corresponding to a trajectory overlap between the target individual u and the individuals V in the second trajectory table within a time range less than the threshold Δt; a relationship profiling between the target individual u and the individuals V in the second trajectory table within the time period [t1, t2] is:

R_{uV}(t₁,t₂)=(A_{uV}(t₁,t₂),M_{uV}(t₁,t₂))

In an embodiment of the present disclosure:

$${C}_{uV} ( {t}_{1} , {t}_{2} ) = {\sum }_{t = {t}_{1}}^{{t}_{2}} I ( {L}_{u} ( t ) = {L}_{V} ( t ) ) ;$$

M_{uV}(t₁,t₂)={Lᵤ(t)|t∈[t₁,t₂],Lᵤ(t)=L_{V}(t)};

$${A}_{u V} ( {t}_{1} , {t}_{2} ) = \frac{{C}_{u V} ( {t}_{1} , {t}_{2} ) \cdot F}{{t}_{2} - {t}_{1}} ;$$

where I is an indicator function, Lᵤ(t) represents the position of the target individual u at time t, L_{V}(t) represents the positions of the individuals V in the second trajectory table at time t, which is 1 when Lᵤ(t)=L_{V}(t), otherwise 0, t∈[t1, t2], and F represents the comprehensive score of all correlation degree influencing factors.

In an embodiment of the present disclosure, in the comprehensive score F of all correlation degree influencing factors: the correlation degree influencing factors include a privacy D of the meeting location; a calculation mechanism of the influence score of the privacy D of the meeting location is as follows: dividing the places in the location database P into different privacy levels, P={p₁, p₂ . . . pₖ}; setting a score for each level, S(p₁), S(p₂) . . . S(pₖ); for each meeting location m∈M_{uV}(t1,t2), using spatial indexing technology to find a nearest place pₘ in the location database P, and obtaining a corresponding score S(pₘ) of the location; Calculating the comprehensive influence score of the privacy D of all meeting locations within the time period [t1, t2]:

$${f}_{D} ( {t}_{1} , {t}_{2} ) = \frac{1}{\vert {M}_{uV} ( {t}_{1} , {t}_{2} ) \vert} {\sum }_{j = 1}^{\vert {M}_{u V} ( {t}_{1} , {t}_{2} ) \vert} S ( {p}_{j} ) ,$$

where |Mᵤᵥ(t₁,t₂)| represents a number of meeting locations, pⱼ represents a location corresponding to a j-th meeting location in M_{uV}(t1,t2) in the location database, and S(pⱼ) represents the level score of the place corresponding to the j-th meeting location.

In an embodiment of the present disclosure, the correlation degree influencing factors include a meeting time T; a calculation mechanism of the influence score of the meeting time T is as follows: setting a relationship function between the score and time:

$${S}_{T} ( {t}_{x} ) = A \cdot sin ( \frac{2 π}{24} {t}_{x} + ϕ ) + B + C \cdot {e}^{- \frac{{( {t}_{x} - {t}_{0} )}^{2}}{2 {σ}^{2}}} ,$$

Where tₓ represents the x-th meeting time, and tₓ∈[t1, t2], A is an amplitude of the sine function, which determines half of a maximum fluctuation range of the score, φ is a phase shift, which is used to adjust an axis of symmetry of the sine function to control the time corresponding to a maximum value, B is an offset, which determines an average value of the score, C is used to control an intensity of an additional weighting term, t0 represents a peak position of the additional weighting term, and σ is used to control an influence range of the additional weighting term;

calculate the comprehensive score of all meeting times T:

$${f}_{T} ( {t}_{1} , {t}_{2} ) = {\sum }_{x = 1}^{y} {α ( 1 - α )}^{y - x} {S}_{T} ( {t}_{x} ) ,$$

where α is a smoothing factor between 0 and 1, the closer it is to 1, the more weight is given to the most recent meeting time, and the closer it is to 0, the more uniform the weight is given to all meeting times, and y is a total number of meeting times.

In an embodiment of the present disclosure, the portrait group profiling of the target location includes: passenger flow profiling, determined based on a number of individuals with overlapping individual trajectories; population profiling, determined based on a group information of individual with overlapping individual trajectories.

In an embodiment of the present disclosure, the vehicle group profiling of the target location includes: traffic flow profiling, determined based on a number of vehicles with overlapping vehicle trajectories; vehicle profiling, determined based on a group information of vehicles with overlapping vehicle trajectories.

The present disclosure has the following beneficial effects:
Construction of complete spatiotemporal trajectory: by aggregating data captured by various perceptual devices, extracting complete spatiotemporal trajectories, and forming continuous and complete spatiotemporal information, which can more accurately reflect the behavioral patterns and activity rules of individuals, provide more in-depth behavioral analysis capabilities, rather than just recording the position at a certain time point;
Establishment of group behavior model: by constructing a location database, a individual trajectory database, and a vehicle trajectory database, it is possible to not only track the behavior of individuals but also analyze the group behavior characteristics in particular locations, such as passenger flow, crowd density, and flow direction. This helps to identify abnormal behavior patterns, improve the level of urban safety management, and timely detect and respond to potential safety hazards, making up for the deficiency of ignoring group behavior analysis in existing technologies;
Evaluation of multi-dimensional correlation degree: when determining the correlation between individuals, multi-dimensional influencing factors such as the privacy of meeting locations, meeting time, and weather are introduced, making the evaluation of correlation degree more accurate and comprehensive. In addition, according to real-time data and environmental changes, the weights of various influencing factors are dynamically adjusted to improve the flexibility and accuracy of evaluation, solving the problem that existing technologies cannot fully evaluate based on simple statistical methods;
Optimized urban management and decision support: by providing detailed and accurate spatiotemporal profiling and group behavior analysis results, the present application provides a solid data foundation for urban management and decision-making. This helps to optimize resource allocation, improve urban operation efficiency and service level, enable urban managers to make more scientific and reasonable decisions, and further improve the intelligent management level of the city.

### BRIEF DESCRIPTION OF DRAWINGS

To more clearly illustrate the technical solutions in the embodiments of the present disclosure or the prior art, the following will briefly introduce the drawings needed in the description of the embodiments or the prior art. Obviously, the drawings in the following description are some embodiments of the present disclosure. For those skilled in the art, other drawings can be obtained according to these drawings without creative labor.

FIG. 1 is a flowchart of a spatiotemporal profiling analysis method for individuals and locations based on perceptual data provided by the present disclosure;

FIG. 2 is a flowchart of spatiotemporal profiling generation;

FIG. 3 is a flowchart of obtaining a relationship profiling.

### DESCRIPTION OF EMBODIMENTS

The technical solutions in the embodiments of the present disclosure will be clearly and completely described below with reference to the accompanying drawings in the embodiments of the present disclosure. Obviously, the described embodiments are only a part of the embodiments of the present disclosure, not all of them.

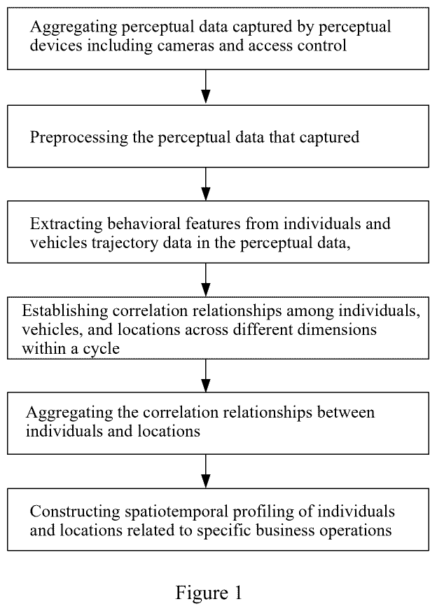

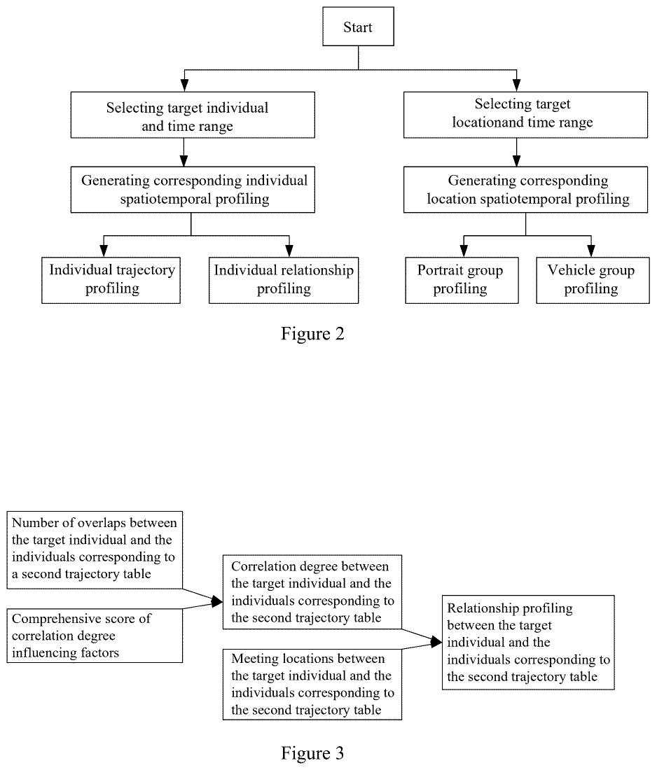

Referring to FIGS. 1-3, a spatiotemporal profiling analysis method for individuals and locations based on perceptual data includes the following steps:

S1: aggregating perceptual data captured by perceptual devices comprising cameras and access control.

S2: preprocessing the perceptual data that captured. Specifically, the preprocessing includes:

Data deduplication and redundancy processing: use a hash function to detect and remove duplicates to reduce storage space.

Data missing value and outlier processing: filling missing values, remove and correct outliers;

Data formatting and standardization: standardize data from different sensors and systems into a unified data type and format;

Data conversion and processing: convert and process data according to different business requirements;

Data quality and reliability verification: verify and evaluate the quality and reliability of data after data cleaning and preprocessing;

Intelligent outlier detection: includes:

Outlier detection based on machine learning: use unsupervised learning algorithms such as Isolation Forest and Autoencoders to automatically detect outliers in data;

Outlier detection based on rules: combine domain knowledge to define some rules to detect abnormal situations, for example, if a person frequently appears in multiple different places in a short time, this may be an abnormal behavior.

S3: extracting behavioral features from individuals and vehicles trajectory data in the perceptual data, classifying and organizing them. Among them, a trajectory comparison algorithm is used to extract complete spatiotemporal trajectories, form continuous and complete spatiotemporal information, and establish relevant databases. The relevant databases include:

Location database: Generate an association database between locations and perceptual devices according to the geographical location of the locations and the latitude and longitude data of perceptual device deployment, and name it a location database. Obtain the association table of the target location in the location database as the first place table, and obtain the association tables in the location database except the first place table as the second place table.

Individual trajectory database: Aggregate the trajectory information of individuals into an individual trajectory database. Obtain the first trajectory table of the target individual in the individual trajectory database, and obtain the trajectory tables in the individual trajectory database except the first trajectory table as the second trajectory table.

Vehicle trajectory database: Aggregate the vehicle trajectory information into a vehicle trajectory database.

S4: Establishing correlation relationships among individuals, vehicles, and locations across different dimensions within a cycle based on the extracted data.

S5: Aggregating the correlation relationships between individuals and locations;

S6: Constructing spatiotemporal profiling of individuals and locations related to specific business operations. The spatiotemporal profiling include:

Relationship profiling: Determine the relationship profiling between the target individual and the individuals corresponding to the second trajectory table according to the correlation degree and meeting locations between the target individual and the individuals corresponding to the second trajectory table.

Trajectory profiling: Determine the trajectory profiling of the target individual according to the number and time of overlap between the trajectory of the target individual and the locations in the location database.

Portrait group portrait of the target location: Determine the portrait group portrait of the target location according to the overlap between the target location and the individual trajectories in the individual trajectory database. Further, the portrait group portrait of the target location includes Passenger flow profiling: Determine the passenger flow profiling according to the number of individuals with overlapping individual trajectories; and Population profiling: Determine the population profiling according to the group information of individual with overlapping individual trajectories.

Vehicle group profiling of the target location: Determine the vehicle group profiling of the target location according to the overlap between the target location and the vehicle trajectories in the vehicle trajectory database. Further, the vehicle group portrait of the target location includes: Traffic flow profiling: Determine the traffic flow profiling according to the number of vehicles with overlapping vehicle trajectories; and Vehicle profiling: Determine the vehicle profiling according to the group information of vehicles with overlapping vehicle trajectories.

Further, in step S6, the acquisition mechanism of the relationship profiling is as follows:

Within the time period [t1, t2], determine the correlation degree A_{uV}(t1, t2) between the target individual u and the individuals V corresponding to the second trajectory table according to the number of trajectory overlaps C_{uV}(t1, t2) between the target individual u and the individuals V={v1, v2, v3 . . . vg} in the second trajectory table within a time range less than the threshold Δt, where q represents the total number of individuals in the second trajectory table.

Within the time period [t1, t2], determine the meeting locations M_{uV}(t1,t2) between the target individual and the individuals corresponding to the second trajectory table according to the position information corresponding to the trajectory overlap between the target individual u and the individuals V in the second trajectory table within a time range less than the threshold Δt.

Then the relationship profiling between the target individual u and the individuals V in the second trajectory table within the time period [t1, t2] is:

R_{uV}(t₁,t₂)=(A_{uV}(t₁,t₂),M_{uV}(t₁,t₂)).

Further, the number of trajectory overlaps is:

$${C}_{uV} ( {t}_{1} , {t}_{2} ) = {\sum }_{t = {t}_{1}}^{{t}_{2}} I ( {L}_{u} ( t ) = {L}_{y} ( t ) ) ;$$

Where I is an indicator function, Lᵤ(t) represents the position of the target individual u at time t, L_{V}(t) represents the position of the individuals V in the second trajectory table at time t, which is 1 when Lᵤ(t)=L_{V}(t), otherwise 0, t∈[t1, t2];

The meeting locations are:

M_{uV}(t₁,t₂)={Lᵤ(t)|t∈[t₁,t₂],Lᵤ(t)=L_{V}(t)};

The correlation degree is:

$${A}_{u V} ( {t}_{1} , {t}_{2} ) = \frac{{C}_{u V} ( {t}_{1} , {t}_{2} ) \cdot F}{{t}_{2} - {t}_{1}} ;$$

Where F represents the comprehensive score of all correlation degree influencing factors, and the accuracy and comprehensiveness of the correlation degree can be improved by setting this parameter.

Further, the correlation degree influencing factors include the privacy D of the meeting location. The calculation mechanism of the influence score of the privacy D of the meeting location is as follows:
Divide the locations in the location database P into different privacy levels, P={p₁, p₂ . . . pₖ}, set a score for each level, S(p₁), S(p₂) . . . S(pₖ), all scores are between [H1, H2]. Specifically, divide the privacy of locations into several levels according to existing research and standards, which are very public: such as parks, squares, etc.; relatively public: such as cafes, shopping malls, etc.; moderately private: such as offices, libraries, etc.; relatively private: such as living rooms of private residences, hotel lobbies, etc.; very private: such as bedrooms of private residences, hotel rooms, etc., and set scores for these levels in turn, for example, 1, 3, 5, 7, 10 in turn;
For each meeting location, use spatial indexing technology to find the nearest place pₘ in the location database P, and obtain the corresponding score S(pₘ) of the location as the score of the meeting location;
Calculate the comprehensive influence score of the privacy D of all meeting locations within the time period [t1, t2]:

$${f}_{D} ( {t}_{1} , {t}_{2} ) = \frac{1}{\vert {M}_{uV} ( {t}_{1} , {t}_{2} ) \vert} {\sum }_{j = 1}^{\vert {M}_{uV} ( {t}_{1} , {t}_{2} ) \vert} S ( {p}_{j} ) ;$$

Where |Mᵤᵥ(t₁,t₂) represents the number of meeting locations, pⱼ represents the location corresponding to the j-th meeting location in M_{uV}(t1,t2) in the location database, and S(pⱼ) represents the level score of the place corresponding to the j-th meeting location.

Further, the correlation degree influencing factors include the meeting time T. The calculation mechanism of the influence score of the meeting time T is as follows:

Set the relationship function between the score and time:

$${S}_{T} ( {t}_{x} ) = A \cdot sin ( \frac{2 π}{24} {t}_{x} + ϕ ) + B + C \cdot {e}^{- \frac{{( {t}_{x} - {t}_{0} )}^{2}}{2 {σ}^{2}}} ,$$

Where tₓ represents the x-th meeting time, and tₓ∈[t1, t2], A is the amplitude of the sine function, which determines half of the maximum fluctuation range of the score, Y is the phase shift, which is used to adjust the axis of symmetry of the sine function to control the time corresponding to the maximum value, B is the offset, which determines the average value of the score, C is used to control the intensity of the additional weighting term, t0 represents the peak position of the additional weighting term, and σ is used to control the influence range of the additional weighting term. For example, set A=4.5, B=5.5, φ=3π/2, C=2, t0=0, σ=3, which means that the score is the highest during the midnight period (00:00 to 06:00), and the lowest during the day, especially from noon to evening. It should be noted that when calculating the correlation degree by integrating multiple influencing factors, the values of the parameters in this formula need to be set so that S_{T}(tₓ)∈[H1, H2], which can correspond to the range of the score values of the privacy of the meeting location;

Calculate the scores of all meeting times T using the relationship function between the score and time;

Calculate the comprehensive score of all meeting times T:

$${f}_{T} ( {t}_{1} , {t}_{2} ) = {\sum }_{x = 1}^{y} {α ( 1 - α )}^{y - x} {S}_{T} ( {t}_{x} ) ,$$

Where S_{T}(tₓ) is the score of the x-th meeting time, a is a smoothing factor between 0 and 1, the closer it is to 1, the more weight is given to the most recent meeting time, and the closer it is to 0, the more uniform the weight is given to all meeting times, and y is the number of meeting times.

For example, there are three meeting time points and their corresponding scores: t_{A}=0 (midnight), score S(t_{A})=10.00; t_{B}=6 (6:00 am), score S(t_{B})=3.55; t_{C}=12 (12:00 noon), score S(t_{C})=1.00; set the smoothing factor α=0.5;

Calculate the weight of each time period:

For t3 (the most recent time period): the weight is:

α(1−α)³⁻³=0.5×(1−0.5)⁰=0.5;

For t2 (the second most recent time period): the weight is

α(1−α)³⁻²=0.5×(1−0.5)¹=0.25;

For t1 (the farthest time period): the weight is:

α(1−α)³⁻¹=0.5×(1−0.5)²=0.125;

Then the comprehensive score of the influencing factor of meeting time is:

f_{T}(M_{uV}(t₁,t₂))=0.5×1.00+0.25×3.55+0.125×10.00=2.64.

Using this method to calculate the comprehensive score of the influencing factor of meeting time T, as time goes by, the weight of earlier data points will gradually decrease, thereby reducing the impact of old data on the current value. This helps the model better adapt to new trends and patterns and reflect the latest changes faster, and to a certain extent smooths the data and reduces data fluctuations caused by individual outliers or noise.

### Embodiment 1

The correlation degree influencing factors include weather W;

Divide the weather into several levels, and set a basic score for each level. For example, the basic score is between 1-10: sunny day: 1; cloudy day: 2; overcast day: 3; light rain: 4; moderate rain: 5; heavy rain: 6; torrential rain: 7; snow: 8; heavy snow: 9; extreme weather (such as typhoon, tornado, etc.): 10;

Set the relationship function between the meeting weather and the score, and calculate the final score of the meeting weather:

S_{W}(t_{z})=ε·W(t_{z})·S_{T}(t_{z}),

Where W(t_{z}) represents the basic score corresponding to the z-th meeting weather, S_{T}(t_{z}) is the score of the z-th meeting time, and P is the adjustment factor. It is worth noting that when comprehensively calculating the score with other influencing factors, set the basic score∈[H1, H2], and set the value of t so that the value range of S_{W}(t) can fall into [H1, H2], which can normalize the value and then unify it with the score range of other influencing factors. Using this formula, combining the two dimensions of time and weather, more abundant information can be provided to help better understand the reasons behind the data. For example, heavy rain in the middle of the night may have a greater impact on people than heavy rain during the day, because the visibility is low at night, traffic is inconvenient, and people may be more reluctant to go out. By combining the time factor, the correlation degree between the target individual u and the individuals V in the second trajectory table can be evaluated more accurately.

Obtain the weather conditions at the time of the meeting by calling the weather API, and obtain the scores of all meeting weather according to the above formula;

Calculate the comprehensive score of the weather influencing factor W:

$${f}_{W} ( {t}_{1} , {t}_{2} ) = \frac{1}{{C}_{u V} ( {t}_{1} , {t}_{2} )} {\sum }_{z = 1}^{{C}_{u V}} {S}_{W} ( {t}_{z} ) ,$$

Where S_{w}(t_{z}) represents the final score of the z-th meeting weather, and C_{uV}(t1, t2) is the number of trajectory overlaps.

### Embodiment 2

The influencing factors include the degree of user's facial expression change E;

Real-time capture the user's facial expressions through facial recognition sensors such as cameras, and use tools such as OpenCV or Dlib to detect facial key points such as eyes, mouth, eyebrows, etc. The position and shape of these key points can be used to infer the user's expression;

Classify expressions: the classification methods include rule-based methods: judge expressions by defining some rules according to the changes in the position and shape of key points, for example, if the corners of the mouth rise and the eyes curve, it can be judged as a smile; machine learning methods: train a classifier such as SVM, random forest, neural network, etc., use the labeled expression data set for training, and then classify new facial images; pre-trained models: use pre-trained expression recognition models, such as Fer2013, AffectNet, etc., which have been trained on large-scale data sets and can be directly applied;

Calculate the expression change score: record the position of key points at each time point, calculate the change amount of key point positions between adjacent time points, for example, calculate the Euclidean distance or cosine similarity, calculate the change amount of key point positions between adjacent time points, the greater the change amount, the higher the score;

Divide the degree of expression change into levels and set basic scores, such as no change: 0; slight change: 2; moderate change: 4; significant change: 7; great change: 10, and then obtain the basic score of the user's expression change at each meeting.

Set a formula to calculate the final score of expression change at each meeting:

$${S}_{E} ( {t}_{E 1 l} , {t}_{E 2 l} ) = λ \cdot ( {E}_{u} + {E}_{V} ) \cdot max ( \frac{{E}_{u}}{{E}_{ma x}} , \frac{{E}_{V}}{{E}_{m ax}} )$$

Where t_{E1l} is the start time of the 1-th meeting, that is, the initial collection time of expression data, t_{E2l} is the time after the 1-th meeting, that is, the final collection time of expression data, and t_{E1l}, t_{E2l}∈[t1, t2], λ is the adjustment factor, and the basic score range is [H1, H2], which aims to normalize the final score so that the output result is within [H1, H2], and then corresponds to the score range of other influencing factors. Eᵤ is the expression change score of the target individual, E_{V} is the expression change score of the personnel in the second trajectory table, and Eₘₐₓ is the maximum value of the expression change score. Using this formula can comprehensively reflect the degree of expression change of two people at each meeting, and when the degree of expression change of both people is high, the score will be higher.

Calculate the comprehensive score of expression changes at all meetings:

$${f}_{E} ( {t}_{1} , {t}_{2} ) = \frac{1}{{C}_{uV} ( {t}_{1} , {t}_{2} )} {\sum }_{l = 1}^{{C}_{uV} ( {t}_{1} , {t}_{2} )} {{S}_{E} ( {t}_{E 1 l} , {t}_{E 1 l} )}^{γ} \cdot {w}_{l} ;$$

$${w}_{l} = 1 + β \cdot \frac{{S}_{E} ( {t}_{E 1 l} , {t}_{E 2 l} )}{S max} ;$$

Where w₁ is the weight factor of the expression change score of the l-th time, γ is a power exponent used to adjust the nonlinear degree of the score, β is a constant that controls the intensity of the weight factor, and Smax is the maximum value of the final expression change scores at all meetings. By setting the weight factor, meetings in certain specific time periods such as meetings and activities can be given higher weights, thereby occupying a larger proportion in the final score. The weight factor can be dynamically adjusted according to actual data, making the model more flexible and adaptable. By introducing the power exponent γ, it helps to emphasize or weaken the influence of certain scores. For example, if γ>1, high scores will be further amplified; if γ<1, low scores will be relatively amplified.

Based on the above analysis, calculate the comprehensive score of all influencing factors:

### Embodiment 3

The calculation formula of the comprehensive score of correlation degree influencing factors is:

$$F = {( {\prod }_{= 1}^{n} {f}_{i} ( {t}_{1} , {t}_{2} ) )}^{\frac{1}{n}} ,$$

Where i represents different influencing factors, n represents the number of influencing factors, fᵢ(t₁,t₂) represents the comprehensive influence score of the i-th influencing factor within the time period [t1, t2], and p is a positive integer greater than 1. Using this calculation method can reduce the impact of extreme values on the results, make the contributions between various factors more balanced, and provide a relatively stable estimate.

### Embodiment 4

The calculation formula of the score of correlation degree influencing factors is:

$$F = {\sum }_{i = 1}^{n} {w}_{i} \cdot {f}_{i} ( {t}_{1} , {t}_{2} ) ,$$

Where i represents different influencing factors, n represents the number of influencing factors, wᵢ represents the weight of the i-th influencing factor, and fᵢ(t₁,t₂) represents the comprehensive influence score of the i-th influencing factor within the time period [t1, t2]. Among them, wᵢ can be determined by statistical methods such as principal component analysis (PCA), factor analysis, and regression analysis, or adjusted by machine learning methods such as feature importance and optimization algorithms, which can highlight the importance of certain influencing factors.

Further, the acquisition mechanism of the target individual trajectory profiling is as follows:
Determine overlap events: for each location Po in the location database P, check whether the position Lᵤ(t) of the target individual u falls within the geographical scope of the location within the time period [t1, t2]. If it falls within, record an overlap event B_{u,o}(ts,te), where ts is the time of first entry and te is the time of last departure;
Calculate the number of overlaps: for each place Po, count the number of all overlap events to calculate the number of overlaps Nᵤ(Pₒ,t₁,t₂),

Nᵤ(Pₒ,t₁,t₂)=ΣB_{u,o}1,

Where ΣB_{u,o} represents summing all overlap events for the place Pₒ.

Calculate the overlap time: For each place Pₒ, calculate the total overlap time Dᵤ(Pₒ,t₁,t₂) by accumulating the time differences of all overlap events,

Dᵤ(Pₒ,t₁,t₂)=Σ_{B}_{_{u,o}}(tₑ−tₛ);

Construct the trajectory profiling:

Gᵤ(Pₒ,t₁,t₂)={(Pₒ,(Nᵤ(Pₒ,t₁,t₂),Dᵤ(Pₒ,t₁,t₂)),Pₒ∈P}.

The above descriptions are only preferred specific implementations of the present disclosure, but the protection scope of the present disclosure is not limited thereto. Any person skilled in the technical field who is familiar with the technical field of the present disclosure may make equivalent substitutions or changes according to the technical scheme of the present disclosure and its inventive concept within the technical scope disclosed by the present disclosure, which shall all be covered by the protection scope of the present disclosure.

What is claimed is:

1. A spatiotemporal profiling analysis method for individuals and locations based on perceptual data, comprising steps of:
S1: aggregating perceptual data captured by perceptual devices comprising cameras and access control;
S2: preprocessing the perceptual data that captured;
S3: extracting behavioral features from individuals and vehicles trajectory data in the perceptual data, classifying and organizing them, and establishing relevant databases;
S4: establishing correlation relationships among individuals, vehicles, and locations across different dimensions within a cycle based on the extracted data;
S5: aggregating the correlation relationships between individuals and locations;
S6: constructing spatiotemporal profiling of individuals and locations related to specific business operations.

2. The analysis method according to claim 1, wherein the preprocessing in step S2 comprises:
deduplication and redundancy processing of data by detecting and removing duplicates using hash function to reduce storage space;
processing missing values and outliers by filling missing values, removing and correcting outliers;
formatting and standardizing data by standardizing data from different sensors and systems into unified data type and format;
converting and processing data according to different business requirements;
verifying data quality and reliability after data cleaning and preprocessing.

3. The analysis method according to claim 1, wherein the relevant databases in the step S3 comprise:
a location database of associations between the locations and the perceptual devices, which is established based on geographical locations and the latitude and longitude data of the perceptual devices, an association table of a target location being obtained from the location database as a first location table, association tables of those other than the first location obtained from the location database as second location tables;
an individual trajectory database established by aggregating individual trajectory information, a first trajectory table of a target individual being obtained from the individual trajectory database, and second trajectory tables being those obtained from the individual trajectory database other than the first trajectory table; and
a vehicle trajectory database established by aggregating vehicle trajectory information.

4. The analysis method according to claim 3, wherein the spatiotemporal profiling in the step S6 comprise:
relationship profiling between the target individual and individuals corresponding to the second trajectory table, which is determined based on a correlation degree and meeting locations between the target individual and the individual corresponding to the second trajectory table;
trajectory profiling of the target individual, which is determined based on a number and time of overlap between the trajectory of the target individual and the locations in the location database;
portrait group profiling of the target location, which is determined based on an overlap between the target location and the individual trajectories in the individual trajectory database;
vehicle group profiling of the target location, which is determined based on an overlap between the target location and the vehicle trajectories in the vehicle trajectory database.

5. The analysis method according to claim 4, wherein the acquisition mechanism of the relationship profiling is as follows:
within a time period [t1, t2], determining the correlation degree A_{uV}(t1, t2) between the target individual u and the individuals V corresponding to the second trajectory table according to the number of trajectory overlaps C_{uV}(t1, t2) between the target individual u and the individuals V={v1, v2, v3 . . . vg} in the second trajectory table within a time range less than a threshold Δt, where q represents a total number of individuals in the second trajectory table;
within the time period [t1, t2], determining the meeting locations M_{uV}(t1,t2) between the target individual and the individuals corresponding to the second trajectory table according to the position information corresponding to a trajectory overlap between the target individual u and the individuals V in the second trajectory table within a time range less than the threshold Δt;
a relationship profiling between the target individual u and the individuals V in the second trajectory table within the time period [t1, t2] is:
R_{uV}(t₁,t2)=(A_{uV}(t₁,t₂),M_{uV}(t₁,t₂).

6. The analysis method according to claim 5, wherein:
$${C}_{uV} ( {t}_{1} , {t}_{2} ) = {\sum }_{t = {t}_{1}}^{{t}_{2}} I ( {L}_{u} ( t ) = {L}_{V} ( t ) ) ;$$
M_{uV}(t₁,t₂)={Lᵤ(t)|t∈[t₁,t₂],Lᵤ(t)=L_{V}(t)};
$${A}_{u V} ( {t}_{1} , {t}_{2} ) = \frac{{C}_{u V} ( {t}_{1} , {t}_{2} ) \cdot F}{{t}_{2} - {t}_{1}} ;$$
where I is an indicator function, Lᵤ(t) represents the position of the target individual u at time t, L_{V}(t) represents the positions of the individuals V in the second trajectory table at time t, which is 1 when Lᵤ(t)=L_{V}(t), otherwise 0, t∈[t1, t2], and F represents the comprehensive score of all correlation degree influencing factors.

7. The analysis method according to claim 6, wherein in the comprehensive score F of all correlation degree influencing factors:
the correlation degree influencing factors comprise a privacy D of the meeting location;
a calculation mechanism of the influence score of the privacy D of the meeting location is as follows:
dividing the locations in the location database P into different privacy levels, P={p₁, p₂ . . . pₖ};
setting a score for each level, S(p₁), S(p₂) . . . S(pₖ);
for each meeting location m∈M_{uV}(t1,t2), using spatial indexing technology to find a nearest place pₘ in the location database P, and obtaining a corresponding score S(pₘ) of the location;
calculating the comprehensive influence score of the privacy D of all meeting locations within the time period [t1, t2]:
$${f}_{D} ( {t}_{1} , {t}_{2} ) = \frac{1}{\vert {M}_{uV} ( {t}_{1} , {t}_{2} ) \vert} {\sum }_{j = 1}^{\vert {M}_{u V} ( {t}_{1} , {t}_{2} ) \vert} S ( {p}_{j} ) ,$$
where |Mᵤᵥ(t₁,t₂)| represents a number of meeting locations, pⱼ represents a location corresponding to a j-th meeting location in M_{uV}(t1,t2) in the location database, and S(pⱼ) represents the level score of the place corresponding to the j-th meeting location.

8. The analysis method according to claim 6, wherein:
the correlation degree influencing factors comprise a meeting time T;
a calculation mechanism of the influence score of the meeting time T is as follows:
setting a relationship function between the score and time:
$${S}_{T} ( {t}_{x} ) = A \cdot sin ( \frac{2 π}{24} {t}_{x} + ϕ ) + B + C \cdot {e}^{- \frac{{( {t}_{x} - {t}_{0} )}^{2}}{2 {σ}^{2}}} ,$$
where tₓ represents the x-th meeting time, and tₓ∈[t1, t2], A is an amplitude of the sine function, which determines half of a maximum fluctuation range of the score, φ is a phase shift, which is used to adjust an axis of symmetry of the sine function to control the time corresponding to a maximum value, B is an offset, which determines an average value of the score, C is used to control an intensity of an additional weighting term, t0 represents a peak position of the additional weighting term, and σ is used to control an influence range of the additional weighting term;
calculating the comprehensive score of all meeting times T:
$${f}_{T} ( {t}_{1} , {t}_{2} ) = {\sum }_{x = 1}^{y} {α ( 1 - α )}^{y - x} {S}_{T} ( {t}_{x} ) ,$$
where α is a smoothing factor between 0 and 1, the closer it is to 1, the more weight is given to the most recent meeting time, and the closer it is to 0, the more uniform the weight is given to all meeting times, and y is a total number of meeting times.

9. The analysis method according to claim 4, wherein the portrait group profiling of the target location comprises:
passenger flow profiling, determined based on a number of individuals with overlapping individual trajectories;
population profiling, determined based on a group information of individual with overlapping individual trajectories.

10. The analysis method according to claim 4, wherein the vehicle group profiling of the target location comprises:
traffic flow profiling, determined based on a number of vehicles with overlapping vehicle trajectories;
vehicle profiling, determined based on a group information of vehicles with overlapping vehicle trajectories.
